(19) United States
(12) Patent Application Publication
(10) Pub. No.: US 2026/0348440 A1
(43) Pub. Date: Nov. 5, 2026

(54) DISC FOR VENTILATED DISC BRAKES

(71) Applicant: Brembo S.p.A., Curno, Bergamo (IT)

(72) Inventors: Matteo BOTTIN, Curno, Bergamo (IT); Francesco MENSI, Curno, Bergamo (IT); Paolo OLDONI, Curno, Bergamo (IT)

(21) Appl. No.: 19/117,659

(22) PCT Filed: Oct. 12, 2023
(86) PCT No.: PCT/IB2023/060273

§ 371 Date: Apr. 2, 2025

(30) Foreign Application Priority Data
Oct. 17, 2022 (IT) 102022000021309

(51) Int. Cl. F16D 65/12; F16D 65/02

(52) U.S. Cl. CPC F16D 65/128; F16D 65/126; F16D 2065/132; F16D 2065/1328; F16D 2200/0065

(57) ABSTRACT

The present invention relates to a disc (1) for disc brakes of the ventilated type comprising an annular braking band (2) and an annular ventilation portion (5) of the disc, wherein said braking band (2) and said ventilation portion (5) comprise a plurality of layers of carbon fibers (100, 101, 102, 103) stacked along an overlap axis oriented parallel to a rotation axis (X-X) of the disc (1), said braking band (2) comprises two plates (3, 4) which are coaxial and spaced apart from each other in an axial direction (A-A) delimiting said ventilation portion (5), said plates (3, 4) comprising two outer surfaces (6, 7) which define opposite braking surfaces, said ventilation portion (5) comprises an outer radial edge (8), an inner radial edge (9), and a plurality of protuberances (10) which protrude from said inner radial edge (9) in the radial direction (R-R) towards the rotation axis (X-X), wherein said protuberances (10) define a plurality of compartments (11) each positioned between one protuberance and the other, said ventilation portion (5) comprises a plurality of ventilation channels (17) circumferentially distributed over at least two rows, said ventilation channels (17) lead with respective first openings (18) into said outer radial edge (8) of the ventilation portion (5) and with respective second openings (19) into said compartments (11), said first openings (18) being circumferentially distributed over at least two rows (37, 47) forming respective circumferences, said ventilation channels (17) are grouped into respective clusters (20), and the ventilation channels (17a, 17b, 17c, 17d) of each cluster (20) lead with said second openings (19) into the same compartment (11).

### FIELD OF THE INVENTION

The present invention relates to a disc for disc brakes of the ventilated type comprising a plurality of carbon fiber layers. More in particular, the present invention relates to a disc for disc brakes of the ventilated type comprising a braking band capable of a high cooling efficiency.

### BACKGROUND ART

The use of discs for disc brakes made from carbon-based materials, so-called “Carbon Carbon” or “C/C”, is known. These are composite materials consisting of a carbon matrix in which carbon reinforcing fibers are arranged.

The discs made of “C/C” material are obtained by means of a process involving overlapping of layers or sheets of carbon fibers in the form of woven and/or non-woven fabric to form the so-called carbonaceous “preform,” possible addition of resins, possible subsequent heat treatments, and carbon densification processes. The latter lead to an increase in density such as to give the material adequate mechanical, thermal, and tribological properties, for example a 2- to 6-fold increase in density.

To work as a friction material, the “C/C” material needs high application temperatures, which make the discs made of “C/C” material particularly suitable for use in the racing field and aviation applications.

As it is known, said discs comprise a braking band provided with two opposite braking surfaces intended to cooperate with a pair of opposing pads of a brake caliper. The caliper, hydraulically actuated by a cylinder/piston assembly, presses the pads against the braking surfaces of the braking band. Therefore, the braking action is produced by the friction between the pads and the braking surfaces of the braking band of the disc.

The friction of the pads against the braking band of the disc results in the dissipation of the kinetic energy of the masses to be braked into heat, which produces an increase in the disc temperature, which is particularly high at the braking surface. Therefore, the braking band is required to exhibit a cooling efficiency as high as possible.

For this reason, in the discs of the ventilated type, the braking band is obtained by means of two plates whose outer surfaces define the two braking surfaces, while the inner surfaces delimit a portion of the disc comprising ventilation channels, also referred to as the ventilation portion, for cooling the disc.

However, the ventilation solutions suggested so far cannot ensure an optimal cooling efficiency, especially considering the increasing demands of automobiles, which are becoming increasingly heavier and faster, resulting in a higher thermal power that the braking system has be able to dissipate.

Therefore, the Problem Underlying the Present invention is to provide a disc for disc brakes of the ventilated type which is capable of providing an optimal cooling efficiency of the braking band, i.e., capable of exchanging higher thermal powers thus ensuring lower operating temperatures.

### SUMMARY OF THE INVENTION

The problem set forth above is solved by a disc for disc brakes of the ventilated type as outlined in the appended claims, the definitions of which form an integral part of the present description.

In particular, object of the present invention is a disc for disc brakes of the ventilated type comprising an annular braking band and an annular ventilation portion of the disc, wherein
said braking band and said ventilation portion comprise a plurality of layers of carbon fibers stacked along an overlap axis oriented parallel to a rotation axis of the disc,
said braking band comprises two plates which are coaxial and spaced apart from each other in an axial direction delimiting said ventilation portion, said axial direction being either coincident with or parallel to the rotation axis of the disc, said plates comprising two outer surfaces which define opposite braking surfaces,
said ventilation portion comprises an outer radial edge, an inner radial edge, and a plurality of protuberances which protrude from said inner radial edge in the radial direction towards the rotation axis, wherein said protuberances define a plurality of compartments each positioned between one protuberance and the other,
said disc being characterized in that:
said ventilation portion comprises a plurality of ventilation channels circumferentially distributed over at least two rows, said ventilation channels being adapted to guarantee a flow of cooling fluid between the two plates,
said ventilation channels lead with respective first openings into said outer radial edge of the ventilation portion and with respective second openings into said compartments, said first openings being circumferentially distributed over at least two rows forming respective circumferences,
said ventilation channels are grouped into respective clusters, and the ventilation channels of each cluster lead with said second openings into the same compartment.

The particular distribution of the ventilation channels within the ventilation portion of the disc of the present invention, i.e., the circumferential arrangement thereof on at least two rows and the fact that they lead into the outer radial edge of the ventilation portion with respective openings which are circumferentially distributed on at least two rows to form respective circumferences, gives the disc of the invention an increased cooling capacity of the braking band compared to the existing discs which have different distributions of the ventilation channels, in particular on a single row.

Indeed, it has been surprisingly found that, also by virtue of a significant increase in the heat exchange surface, higher values of exchanged thermal powers are obtained, which, in turn, advantageously result in lower operating temperatures.

In order to better understand the invention and appreciate the advantages thereof, some non-limiting exemplary embodiments thereof will be described below with reference to the accompanying drawings.

### BRIEF DESCRIPTION OF THE FIGURES

FIG. 1 is an isometric view of a disc for disc brakes from the braking band side facing the vehicle, which shows the braking band, more in particular a plate thereof, and the ventilation portion of the disc, according to an embodiment of the invention.

FIG. 2 is an isometric view of a disc for disc brakes from the braking band side facing the vehicle wheel, which shows the braking band, more in particular the plate opposite to that visible in FIG. 1, and the ventilation portion of the disc, according to an embodiment of the invention.

FIG. 3 is a side view of a disc for disc brakes which shows the plates of the braking band and the outer radial edge of the ventilation portion, according to an embodiment of the invention.

FIG. 3A is an enlargement of the dashed area in FIG. 3.

FIG. 4 is a section view along axis D-D shown in FIG. 3.

FIG. 4A is an enlargement of the cluster of ventilation channels highlighted in FIG. 4.

FIG. 5 is a front view of a disc for disc brakes from the braking band side facing the vehicle, which shows the braking band, more in particular a plate thereof, and the ventilation portion of the disc, according to an embodiment of the invention.

FIG. 6 is a front view of a disc for disc brakes from the braking band side facing the vehicle wheel, which shows the braking band, more in particular the plate opposite to that visible in FIG. 5, and the ventilation portion of the disc, according to an embodiment of the invention.

FIG. 7 shows a perspective view of a set of overlapping carbon layers usable to manufacture a disc for disc brakes according to an embodiment of the invention.

FIGS. 8 and 9 diagrammatically show a radial segment and a transverse segment, respectively, usable to manufacture the carbon layers of a disc for disc brakes according to an embodiment of the invention.

### DESCRIPTION OF SOME PREFERRED EMBODIMENTS

With reference to the figures, a disc for disc brakes (also referred to as a “brake disc” in the present application), in particular a brake disc of the ventilated type, is generally indicated by reference numeral 1.

Said brake disc 1 is adapted to rotate about a rotation axis X-X. Said brake disc 1 defines an axial direction A-A, either coinciding with or parallel to the rotation axis X-X, a radial direction R-R, orthogonal to the axial direction A-A, and a tangential or circumferential direction C-C, orthogonal both to the axial direction A-A and to the radial direction R-R.

Said brake disc 1 comprises an annular braking band 2 (more briefly also referred to as a “braking band” in the present application) comprising, in turn, a first plate 3 and a second plate 4 placed side by side, coaxial to the same axial direction A-A and spaced apart from each other in the axial direction A-A so as to delimit at least one annular ventilation portion 5 (more briefly also referred to as a “ventilation portion” in the present application).

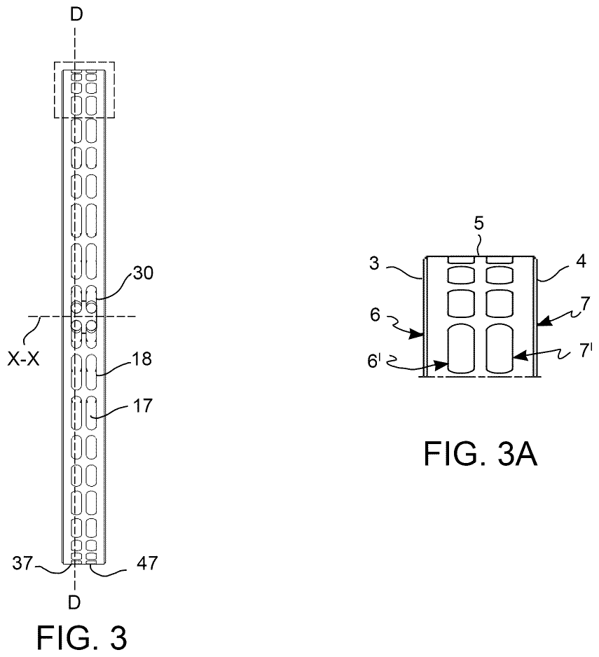

Said first plate 3 is delimited by an outer surface 6 and an inner surface 6′ (shown in FIG. 3A). Similarly, said second plate 4 is delimited by an outer surface 7 and an inner surface 7′ (shown in FIG. 3A). Said surfaces 6, 6′, 7, 7′ extend in planes orthogonal to the rotation axis X-X.

Said outer surfaces 6, 7 define opposite braking surfaces intended to cooperate with a pair of brake pads (not shown) to apply a braking action, while said inner surfaces 6′, 7′ delimit the area within which the aforesaid annular ventilation portion 5 extends.

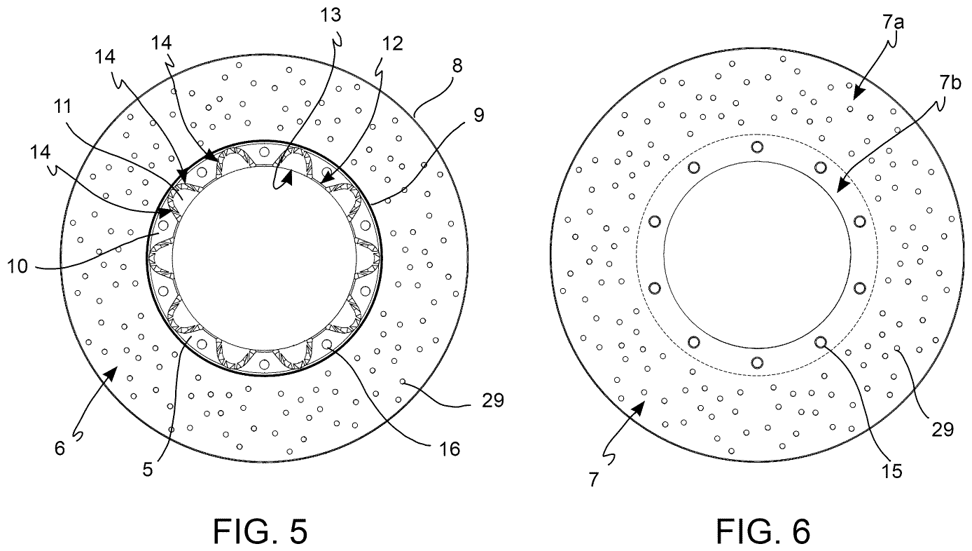

The ventilation portion 5 comprises an outer radial edge 8 and an inner radial edge 9 (the latter shown in FIG. 5).

A plurality of connecting protuberances 10 adapted to be associated with a disc bell (not shown) protrude from the inner radial edge 9 in the radial direction R-R towards the rotation axis X-X. A disc bell is adapted to be operatively connected to a vehicle wheel.

Said protuberances 10 define a plurality of compartments 11, or recesses 11, between one protuberance and the following.

According to a preferred embodiment, each of said protuberances 10 comprises a wall 12 having the profile of an arc of a circumference, as shown in the accompanying figures (see FIG. 5 for example).

The walls 12 extend circumferentially. If joined, the walls 12, spaced out by the aforesaid compartments 11, would form a radial edge 13 (shown in FIG. 5) coaxial to the radial edges 8, 9 of the ventilation portion 5.

According to a preferred embodiment, said compartments 11 have the profile of a dome with a semicircular, parabolic, or ovoid profile, as shown in the accompanying figures. This means that the protuberances 10 defining the aforesaid compartments 11 have two curved side walls 14; for example, said side walls 14 have the profile of a semi-dome with a semicircular, parabolic, or ovoid profile. More in particular, one of the side walls 14 of a protuberance 10 forms, with the adjacent side wall 14 of the following protuberance 10, one of the aforesaid compartments 11 (shown in FIG. 5, for example).

The braking band 2 comprises a vehicle-facing side, adapted to face the vehicle, and a side opposite to the vehicle (or wheel-facing side), axially opposite to the vehicle-facing side and adapted to face a vehicle wheel. The bell is associated with the side of the braking band 2 facing the wheel.

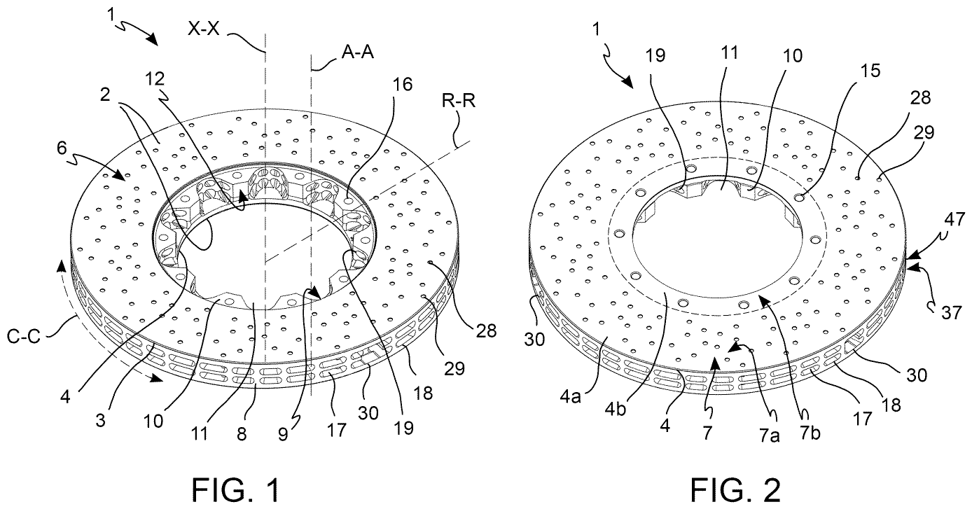

FIGS. 1 and 5 show the brake disc 1 from the side facing the vehicle; FIGS. 2 and 6 show the brake disc 1 from the side facing the vehicle wheel.

The braking band 2 comprises said first plate 3 on the vehicle-facing side, and said second plate 4 on the side facing the vehicle wheel.

Advantageously, said first plate 3 has a smaller extension in the radial direction R-R, towards the rotation axis X-X, than said second plate 4. Advantageously, the protuberances 10 and the corresponding compartments 11 protrude in the radial direction R-R from said first plate 3 (as shown in FIG. 1, for example), but not from said second plate 4. More in particular, the protuberances 10 and the corresponding compartments 11 are topped in the direction R-R by said second plate 4 (as shown in FIG. 2, for example), but not by said first plate 3.

Preferably, said second plate 4 comprises a first annular portion 4a and a second innermost annular portion 4b, shown in FIG. 2, for example.

Said portion 4a comprises an outer surface 7a acting as a braking surface, i.e., it cooperates with a brake pad; said portion 4b comprises an outer surface 7b, which is not part of the braking surface.

Preferably, the outer surface 6 of the first plate 3 corresponds to the braking surface, i.e., said outer surface 6 cooperates, as a whole, with a brake pad.

Preferably, the first annular portion 4a of the second plate 4 has the same extension, or substantially the same extension, as the first plate 3. This means that, preferably, the two opposite braking surfaces have the same or substantially the same extension.

Advantageously, the portion 4b of the second plate 4 comprises a plurality of circumferentially arranged seats 15. Similarly, each protuberance 10 comprises a seat 16 in correspondence with one of the seats 15 obtained in the portion 4b of the second plate 4. Therefore, preferably, said portion 4b comprises a number of seats 15 equal to the number of protuberances 10. Said seats 15 and 16 are adapted to accommodate appropriate devices for connecting the bell to the braking band 2 of the disc. Such devices, being known in the field, are not further described in the present patent application.

The ventilation portion 5 comprises a plurality of ventilation channels, generally indicated by reference numeral 17, adapted to ensure a flow of cooling fluid between the two plates 3, 4. In the embodiment shown in the accompanying figures, said ventilation channels 17 are circumferentially distributed in two rows 37, 47 as shown in FIGS. 1-3. According to other embodiments, not shown, the ventilation portion can comprise a plurality ventilation channels circumferentially distributed over more than two rows, e. g., over three rows, or over four rows, or over five rows.

The following description refers to the embodiment shown in the accompanying figures, in which the ventilation channels are circumferentially distributed over two rows; however, it can be equally applied also to embodiments in which the ventilation channels are circumferentially distributed over more than two rows.

Preferably, the ventilation channels 17 in the row 37 are aligned, along the axial direction A-A, with the ventilation channels 17 in the adjacent row 47, as shown in the accompanying figures. The following description will refer to this preferred embodiment, although it should not be considered limiting for the purposes of the present invention. An alternative embodiment can provide that the ventilation channels 17 in the row 37 be angularly offset with respect to the ventilation channels 17 in the adjacent row 47.

The ventilation channels 17 lead with respective first openings 18 into the outer radial edge 8 of the ventilation portion 5 and with respective second openings 19 into the aforesaid compartments 11.

In the embodiment shown in the accompanying figures, said first openings 18 are mutually equidistant and are circumferentially distributed in two rows forming two circumferences. According to other embodiments, not shown, said first openings 18 are not mutually equidistant.

The cooling fluid (preferably air) enters through said second openings 19, while it comes out through said first openings 18. Therefore, the compartments 11 define the inlet surface of the cooling fluid, while the outer radial edge 8 of the ventilation portion 5 defines the outlet surface thereof.

In the accompanying figures, in particular in FIGS. 1-3, processing ports indicated by reference numeral 30 are shown. They are substantially used to hold the brake disc 1 stationary on special machinery during the possible application of a protective layer, such as silicon carbide, for example, by known application methods comprising chemical vapor deposition (CVD), metal deposition or laser deposition.

The ventilation channels 17 are grouped into clusters 20. The ventilation channels 17 belonging to the same cluster 20 lead with said second openings 19 into the same compartment 11.

Each of said clusters 20 can comprise from 3 to 14 ventilation channels 17, preferably from 4 to 12 ventilation channels 17 or from 4 to 10 ventilation channels 17, e.g., 4, 5, 6, 7, 8, 9, 10 ventilation channels 17, per row. In the following description, although not repeated each time, when speaking about ventilation channels of the same cluster, reference is always made to the ventilation channels “per row” of the same cluster. Therefore, when there are two rows, the total number of the ventilation channels in each cluster will be twice the number indicated each time; when there are three rows, the number of the ventilation channels in each cluster will be triple, and so on.

Preferably, the most peripheral ventilation channels 17 of each cluster 20, i.e., those forming the ends of each cluster 20 or those adjacent thereto, have a greater inner ventilation area than the innermost ventilation channels 17.

More preferably, the first openings 18 of the most peripheral ventilation channels 17 of each cluster 20 have a greater surface extension, preferably a greater extension in the circumferential direction C-C (also referred to as the “circumferential width”), than the first openings 18 of the innermost ventilation channels 17 of each cluster 20. Preferably, the ventilation channels 17 belonging to the same cluster 20 lead into a compartment 11 with second openings 19 having the same surface extension.

It has been surprisingly found that the aforesaid geometric configuration of the ventilation channels of each cluster ensures greater structural strength and greater heat transfer.

According to a preferred embodiment, shown in the accompanying figures, each of said clusters 20 comprises 4 ventilation channels 17. More in particular, each of said clusters 20 comprises a first peripheral ventilation channel 17a, a second peripheral ventilation channel 17b, and two further inner ventilation channels 17c, 17d placed between said peripheral ventilation channels 17a, 17b.

Preferably, said peripheral ventilation channels 17a, 17b have a greater inner ventilation area than the inner ventilation channels 17c, 17d. More preferably, said peripheral ventilation channels 17a, 17b lead into the outer radial edge 8 of said ventilation portion 5 with respective first openings 18 having a greater surface extension, preferably a greater extension in the circumferential direction, than the first openings 18 of the inner ventilation channels 17c, 17d. Preferably, all four ventilation channels 17a, 17b, 17c, 17d lead into a compartment 11 with second openings 19 having the same surface extension.

According to an embodiment, not shown, each cluster 20 comprises 5 ventilation channels 17. According to this embodiment, preferably, each cluster 20 comprises two peripheral ventilation channels and three inner ventilation channels placed between said two peripheral ventilation channels. Preferably, said two peripheral ventilation channels have a greater inner ventilation area than the three inner ventilation channels, leading into the outer radial edge 8 of the ventilation portion 5 with respective first openings 18 having a greater surface extension, preferably a greater extension in the circumferential direction, than the first openings 18 of the inner ventilation channels.

According to another embodiment, not shown, each cluster 20 comprises 10 ventilation channels 17. According to this embodiment, preferably, each cluster 20 comprises two groups of peripheral ventilation channels, each comprising two ventilation channels, for a total of four peripheral ventilation channels; two groups of inner ventilation channels, each adjacent to one of said groups of peripheral ventilation channels and each comprising two ventilation channels, for a total of four inner ventilation channels; two even more internal ventilation channels placed between the two groups of inner ventilation channels. Preferably, the four peripheral ventilation channels have a greater inner ventilation area than the four inner ventilation channels which, in turn, have a greater inner ventilation area than the two even more internal ventilation channels.

According to a further embodiment, not shown, each cluster 20 comprises 12 ventilation channels 17. According to this embodiment, preferably, each cluster 20 comprises two groups of peripheral ventilation channels, each comprising two ventilation channels, for a total of four peripheral ventilation channels; two groups of inner ventilation channels, each adjacent to one of said groups of peripheral ventilation channels and each comprising two ventilation channels, for a total of four inner ventilation channels; two groups of even more internal ventilation channels placed between the two groups of inner ventilation channels and each comprising two ventilation channels, for a total of four innermost ventilation channels. Preferably, the four peripheral ventilation channels have a greater inner ventilation area than the four inner ventilation channels which, in turn, have a greater inner ventilation area than the four innermost ventilation channels.

Preferably, said first openings 18 of the ventilation channels 17 are slot-shaped, as shown in the accompanying figures. The term “slot” denotes geometric figures consisting of two arcs connected to each other by straight lines. Alternatively, said first openings 18 can be elliptical or substantially elliptical or circular or substantially circular in shape.

Preferably, said second openings 19 of the ventilation channels 17 are circular or substantially circular in shape, or are elliptical or substantially elliptical in shape.

In the embodiments in which said first openings are slot-shaped, or elliptical or substantially elliptical in shape, preferably the first openings 18 of the most peripheral ventilation channels 17 of each cluster 20, according to the definition given above, have a greater extension in the circumferential direction C-C than the first openings 18 of the innermost ventilation channels 17 of each cluster 20, and the same extension in the axial direction A-A. For example, in the embodiment described above in which each cluster 20 comprises 4 ventilation channels 17, the peripheral ventilation channels 17a, 17b lead into the outer radial edge 8 of the ventilation portion 5 with respective first openings 18 having a greater circumferential width than the first openings 18 of the inner ventilation channels 17c, 17d, and the same extension in the axial direction, as shown in the accompanying figures.

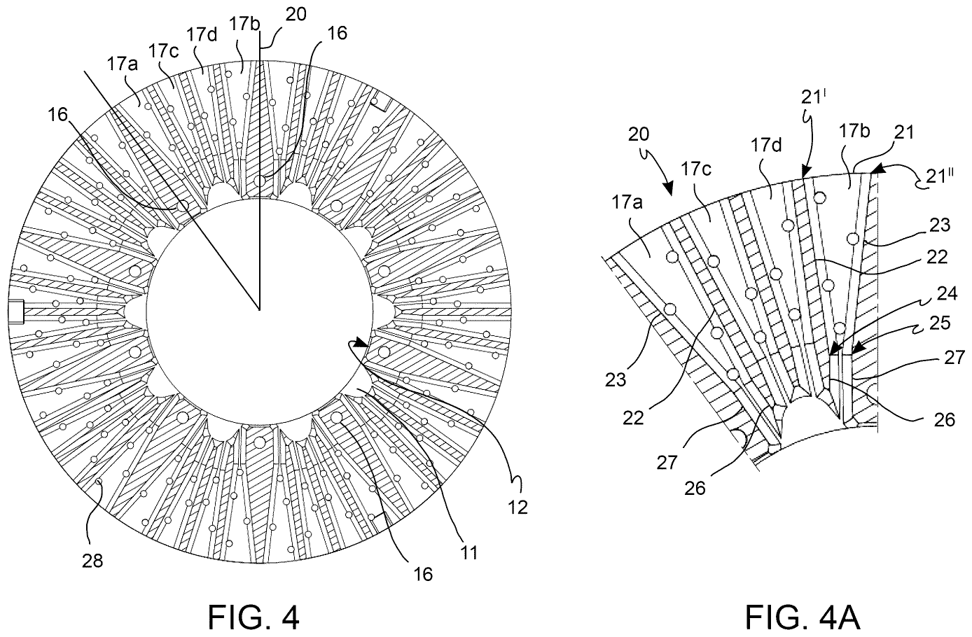

According to a preferred embodiment, shown in FIGS. 4 and 4A, each ventilation channel 17 has a section in a plane perpendicular to the rotation axis X-X defined by:
an arc of circumference 21 at the outer radial edge 8 of the ventilation portion 5;
two straight lines 22, 23 converging away from said outer radial edge 8, said straight lines 22, 23 being delimited by two first ends 21′, 21′', which correspond to the ends of said arc of circumference 21 and by two second ends 24, 25, and
two parallel or substantially parallel straight lines 26, 27, which extend starting from said second ends 24, 25 up to one of said compartments 11.

In this embodiment, the ventilation channels 17 have advantageously a funnel shape or similar shape.

According to an alternative embodiment, not shown in the accompanying figures, each ventilation channel 17 has a section in a plane perpendicular to the rotation axis X-X defined by:
an arc of circumference at the outer radial edge 8 of the ventilation portion 5, and
two straight lines converging away from said outer radial edge 8, said straight lines being delimited by two ends correspond to the ends of said arc of circumference and by two opposite ends in correspondence of one of said compartments 11.

Preferably, each of the aforesaid clusters 20 has a circumferential width in the range of about 25° to about 60°, preferably between about 30° and about 45°, more preferably of about 36°. More in particular, said angle is defined by two radial half-lines (shown in FIG. 4) which intersect at the point of intersection of the rotation axis X-X with an axis oriented along the radial direction R-R, and pass through the center of two seats 16 arranged in two consecutive protuberances 10.

Preferably, the ventilation portion 5 comprises a number of clusters 20 between 6 and 14, preferably between 8 and 12. Advantageously, the number of clusters 20 corresponds to the number of protuberances 10 and of corresponding compartments 11, thus to the number of attachments of the bell.

According to the embodiment shown in the accompanying figures, the ventilation portion 5 comprises ten clusters 20, each defining an angle of 36° or about 36°, hence ten protuberances 10 and ten compartments 11.

According to a preferred embodiment, each cluster 20 comprises four ventilation channels and defines an angle of 36° or about 36°. According to this embodiment, preferably, the peripheral ventilation channels 17a, 17b define an angle between 12° and 15°, e.g., of 14.5°, and the inner ventilation channels 17c, 17d define a lower angle between 8° and 11°, e.g., of 10°. More in particular, the angle defined by each ventilation channel (i.e., the circumferential width of each ventilation channel) is defined by the corresponding converging straight lines 22, 23.

Preferably, the brake disc 1 according to the present invention further comprises a plurality of axial ventilation channels 28. The latter lead with respective openings 29 into the braking surfaces of said first plate 3 and said second plate 4.

Said axial ventilation channels 28 are adapted to ensure a flow of cooling fluid which is substantially orthogonal to the flow of the cooling fluid which flows in the ventilation channels 17 distributed in the ventilation portion 5.

Said axial ventilation channels 28 put the ventilation channels 17 in fluid communication with the braking surfaces.

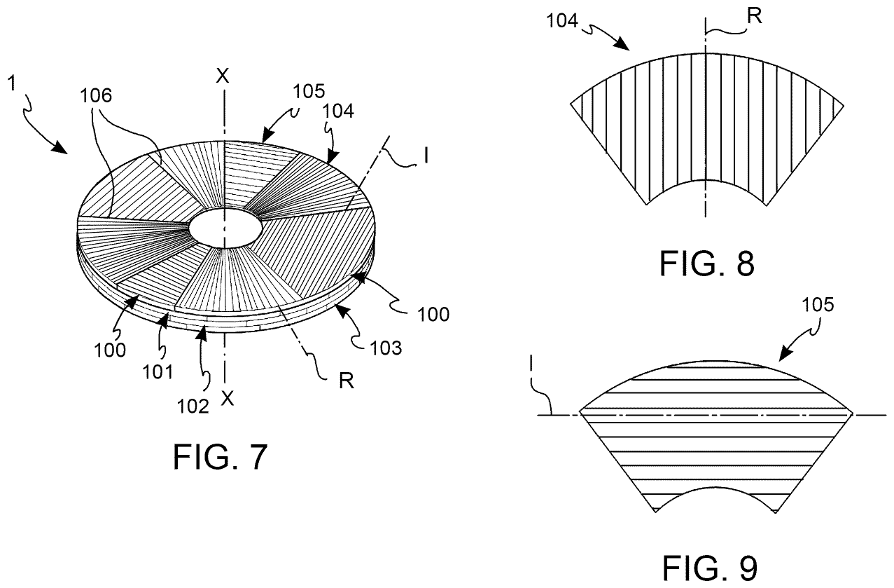

According to a preferred embodiment, the brake disc 1 comprises a plurality of layers of carbon fibers 100, 101, 102, 103, such layers being stacked along an overlap axis, also referred to as a construction axis, oriented parallel to the rotation axis X-X of the disc 1. For simplicity of depiction, four layers 100, 101, 102, 103 are shown in FIG. 7, but this number of layers is merely illustrative and is not intended to be limiting.

In the example shown in FIG. 7, each layer 100, 101, 102, 103 of carbon fibers comprises a plurality of radial segments 104 and transverse segments 105 placed side by side and joined together to form said layer. Each radial segment 104 is adjacent and joined, on both sides, to a transverse segment 105, and each transverse segment 105 is adjacent and joined, on both sides, to a radial segment 104, thus forming in each layer 100, 101, 102, 103 an alternation of radial segments 104 and transverse segments 105.

The radial segments 104 are segments in which the carbon fibers are mainly oriented in a radial direction R relative to the overlap axis, or oriented approximately parallel to the radial direction R. The transverse segments 105 are segments in which the carbon fibers are mainly oriented directed in a direction I incident to the radial direction. In this regard, the diagrams in FIG. 8 and FIG. 9 show, respectively, the orientations of the carbon fibers in a radial direction and in a transverse direction on respective segments 104 and 105.

In a preferred embodiment, the incident direction I is orthogonal or substantially orthogonal with respect to the radial direction R.

In the following description, unless otherwise specified, the terms “radial”, “axial,” “angularly,” “circumferential” are to be understood with respect to the overlap axis.

Advantageously, at least part of said segments 104, 105 are in the form of a circular sector or of a circular crown arch, as shown in FIG. 7.

Preferably, the circumferential width of said circular sectors or circular crown arches is comprised in the range of 60-90°, preferably 60-80°, preferably 65-72°, e.g., of about 68°.

In an embodiment of the invention, all segments 104, 105 have substantially the same shape. Preferably, all segments 104, 105 have the same circumferential width.

In a preferred embodiment, each segment mainly or exclusively comprises unidirectional carbon fibers, arranged either in the radial direction R or in the incident direction I depending on whether it is a radial segment 104 or a transverse segment 105.

In a preferred embodiment, relative to the overlap axis, the segments of a layer 100 are angularly offset with respect to the segments of an adjoining layer 101 so that the joining zones 106 between the segments do not overlap across the thickness of the brake disk 1.

In an embodiment of the invention, relative to the overlap axis, each radial segment 104 of a layer 100 overlaps partly with a radial segment 104 and partly with a transverse segment 105 of an adjoining layer 101. According to this embodiment, each radial segment 104 of a layer 100 overlaps with a radial segment 104 of an adjoining layer 101 over a portion equal to 5%-50%, preferably equal to 10%-40% or 15%~35%, of the circumferential width thereof, and with a transverse segment 105 of the adjoining layer 101 over a portion equal to 50%-95%, preferably equal to 60%-90% or 65%-85%.

Similarly, in an embodiment of the invention, relative to the overlap axis, each transverse segment 105 of a layer 100 overlaps partly with a transverse segment 105 and partly with a radial segment 104 of an adjoining layer 101. According to this embodiment, each transverse segment 105 of a layer 100 overlaps with a transverse segment 105 of an adjoining layer 100 over a portion equal to 5%-50%, preferably equal to 10%-40% or 15%-35%, of the circumferential width thereof, and with a radial segment 104 of the adjoining layer 101 over a portion equal to 50%-95%, preferably equal to 60%-90% or 65%-85%.

In an embodiment (not shown), at least one segment of a layer 100 could be partially overlapped with at least one other segment that is alongside it in a circumferential direction.

Advantageously, in each layer 100, 101, 102, 103, the number of radial segments 104 is equal to the number of transverse segments 105.

In an embodiment of the invention, the segments 104, 105 extend in a spiral around the construction axis in a substantially continuous manner through the plurality of layers 100, 101, 102, 103 of carbon fibers. In this case, the layers 100, 101, 102, 103 are represented by coils. According to this embodiment, preferably, each coil has an inclination comprised in the range between 1° and 10°, preferably between 1° and 5°, e.g., of about 1°, relative to an axis orthogonal to the construction axis.

In the present description, reference is made indiscriminately to layers and coils. Therefore, when the segments 104, 105 extend to form a spiral, it is to be understood that the layers 100, 101, 102, 103 are coils.

In a preferred embodiment, the number of layers 100, 101, 102, 103 of carbon fibers or coils is comprised in the range between 10 and 50, preferably between 18 and 40, e.g., between 20 and 35 or between 24 and 30. In a specific embodiment, the number of layers or coils is between 21 and 26.

By way of mere example, each of said layers 100, 101, 102, 103 of carbon fibers can have a thickness between 0.5 mm and 3 mm, e.g., of about 1.25 mm or 1.5 mm.

By way of mere example, the brake disc 1 of the present invention could have a thickness equal to or greater than about 5 millimeters, for example equal to or greater than about 25 millimeters, for example between about 25 millimeters and about 300 millimeters, e.g., 28 millimeters, 32 millimeters, 34 millimeters, 38 millimeters or 40 millimeters.

In an embodiment of the invention, at least part of said carbon fibers, preferably all the carbon fibers, are derived from oxidized polyacrylonitrile fibers.

In a preferred embodiment, the brake disc 1 comprises a carbonaceous matrix within which at least one part of said carbon fibers is embedded. The expression “carbonaceous matrix” denotes a matrix consisting of at least 50% carbon.

In an embodiment of the invention, the brake disc 1 comprises silicon carbide (SiC) and, optionally, silicon (Si). Silicon carbide (SiC) is obtained by the reaction of part of the carbon (C) of the carbon fibers and/or of the carbonaceous matrix of said brake disc 1 with at least part of silicon (Si) infiltrated into the brake disc 1. Preferably, said silicon carbide (SiC) is arranged as a bridge between adjacent layers 100, 101, 102, 103 of carbon fibers.

Preferably, the brake disc 1 has a residual porosity of less than 5%, e.g., of equal to or less than 3%. Preferably, the value of such a residual porosity is considered for a brake disc 1 comprising silicon carbide (SiC), specifically at the end of at least one step of infiltration with silicon (Si).

Advantageously, the allowable minimum thickness of the plates 3, 4 (i.e., the minimum thickness of the plates worn out due to rubbing of the braking surfaces against the brake pads, without the disc showing structural failures; in other words, the thickness of the worn-out plates at the end of the life cycle of the disc) of a brake disc 1 as described above, in which each layer of carbon fibers is formed by a plurality of radial segments and transverse segments and in which each radial segment is alternated with a transverse segment, is formed by three of the aforesaid carbon fiber layers stacked along the overlap axis. This means that the flexural strength of the plates 3, 4 is ensured by the overlap of three layers of carbon fibers.

In a preferred embodiment, the brake disc 1 of the present invention has a thickness of 34 millimeters or about 34 millimeters. More in particular, each plate 3, 4 has a thickness of 7 millimeters or about 7 millimeters at the beginning of its life cycle, while the ventilation portion has a thickness of 20 millimeters or about 20 millimeters.

The brake disc 1 as described above, in which each layer of carbon fibers is formed by a plurality of radial segments and transverse segments, and in which each radial segment is alternated with a transverse segment, can be manufactured by a method comprising the following steps:
a) stacking a plurality of layers of carbon fibers, or of precursors of said carbon fibers, along an overlap axis to form a multilayer body, each of said layers being formed by a plurality of radial segments and transverse segments, wherein each radial segment is adjacent and joined, on both sides, to a transverse segment, and each transverse segment is adjacent and joined, on both sides, to a radial segment, forming in each layer an alternation of radial segments and transverse segments, optionally said step a) further comprising a step of needling the stacked layers;
b) subjecting the multilayer body obtained in step (a) to a thermal or thermochemical densification treatment, e.g., CVD (Chemical Vapor Deposition), CVI (Chemical Vapor Infiltration), LPI (Liquid Polymer Infiltration) or PIP (Polymer Infiltration and Pyrolysis);
c) optionally, infiltrating the material resulting from step b) with an infiltrating agent, e.g., silicon (Si) or silicon carbide (SiC), preferably by means of a liquid silicon infiltration (LSI) process during which the silicon is brought to a temperature higher than the melting temperature thereof so as to melt and infiltrate by capillarity into the aforesaid material.

### Experimental Part

The following were compared:
1) a brake disc according to the present invention (referred to as “DISC 1” hereinafter) comprising a ventilation portion in which the ventilation channels are circumferentially distributed over two rows, and
2) a brake disc belonging to the prior art (referred to as “DISC 1C” hereinafter) comprising a ventilation portion in which the ventilation channels are circumferentially distributed over one row, leading into the outer radial edge of the ventilation portion with circular or substantially circular openings so as to optimize the heat transfer surface.

More in particular, the DISC 1 is that shown in the accompanying figures, in which each cluster 20 comprises four ventilation channels 17 and has a circumferential width of 36°; wherein each ventilation channel 17 leads into the outer radial edge 8 of the ventilation portion 5 with first openings 18 being slot-shaped; and wherein the peripheral ventilation channels 17a, 17b lead into the outer radial edge 8 of the ventilation portion 5 with slots 18 having a greater extension in the circumferential direction than the slots 18 of the inner ventilation channels 17c, 17d.

The compared DISC 1 and DISC 1C both have a diameter of 390 millimeters and a thickness of 34 millimeters.

The extension of the inlet surface [mm²] o the cooling fluid in the ventilation channels of DISC 1 was found to be about 22% greater than that of DISC 1C.

The extension of the entire inner surface [mm²] of the ventilation channels of DISC 1 was found to be about 75% greater than that of DISC 1C.

The airflow [kg/s] within the ventilation channels of DISC 1 was found to be 16.6% greater than the airflow in the ventilation channels of DISC 1C.

The heat transfer [W] only by the ventilation channels made in the ventilation portion of DISC 1 was found to be 38.8% greater than the heat transfer by the ventilation channels of DISC 1C.

The total heat transfer [W] by DISC 1 (therefore also taking into account the contribution of the axial ventilation channels) was found to be 24.7% greater than the heat transfer by DISC 1C.

The operating temperature of DISC 1 was found to be decreased by 70° C. compared to that of DISC 1C.

In addition to the technical advantages in terms of increased heat transfer, DISC 1 was also found to be lighter, exhibiting a mass decrease of 3%, with the size being the same. In addition, less wear was found on the pads cooperating with said disc.

It is apparent that only a particular embodiment of the present invention has been described herein. Those skilled in the art will be able to make all necessary changes to the disc for disc brakes to adapt it to particular conditions, without however departing from the scope of protection as defined in the appended claims.

### LIST OF REFERENCE NUMERALS

1 Disc for disc brakes
2 Braking band
3 First plate
4 Second plate
4a First annular portion of the second plate
4b Second annular portion of the second plate
5 Ventilation portion
6 Outer surface of the first plate
6′ Inner surface of the first plate
7 Outer surface of the second plate
7′ Inner surface of the second plate
7a, 7b Outer surfaces of portions 4a and 4b of the second plate
8 Outer radial edge of the ventilation portion
9 Inner radial edge of the ventilation portion
10 Connecting protuberances
11 Compartments or recesses
12 Walls of the connecting protuberances placed circumferentially
13 Radial edge delimited by the walls 12
14 Side walls of the connecting protuberances
15 Seats obtained in the second portion 4b of the second plate
16 Seats obtained in the connecting protuberances
17 Ventilation channels
37, 47 Rows of ventilation channels
17a, 17b Peripheral ventilation channels
17c, 17d Inner ventilation channels
18 First openings of the ventilation channels
19 Second openings of the ventilation channels
20 Cluster of ventilation channels
21 Arc of circumference of the section of a ventilation channel
21′, 21″ Ends of the arc of circumference 21
22, 23 Converging straight lines of the section of a ventilation channel
24, 25 Second ends of the straight lines 22, 23
26, 27 Parallel straight lines of the section of a ventilation channel
28 Axial ventilation channels
29 Openings of the axial ventilation channels
30 Processing ports
100-103 Layers of carbon fibers
104 Radial segments
105 Transverse segments
106 Joining zones between radial and transverse segments

1-16. (canceled)

17. A disc for disc brakes of the ventilated type comprising an annular braking band and an annular ventilation portion of the disc, wherein
said braking band and said ventilation portion comprise a plurality of layers of carbon fibers stacked along an overlap axis oriented parallel to a rotation axis of the disc,
said braking band comprises two plates which are coaxial and spaced apart from each other in an axial direction delimiting said ventilation portion, said axial direction being either coincident with or parallel to the rotation axis of the disc, said plates comprising two outer surfaces which define opposite braking surfaces,
said ventilation portion comprises an outer radial edge, an inner radial edge, and a plurality of protuberances which protrude from said inner radial edge in the radial direction towards the rotation axis, wherein said protuberances define a plurality of compartments each positioned between one protuberance and the other,
said disc being characterized in that:
said ventilation portion comprises a plurality of ventilation channels circumferentially distributed over at least two rows, said ventilation channels being adapted to guarantee a flow of cooling fluid between the two plates,
said ventilation channels lead with respective first openings into said outer radial edge of the ventilation portion and with respective second openings into said compartments, said first openings being circumferentially distributed over at least two rows forming respective circumferences,
said ventilation channels are grouped into respective clusters, and the ventilation channels of each cluster lead with said second openings into the same compartment.

18. The disc according to claim 17, wherein each of said clusters comprises from 3 to 14 ventilation channels, preferably from 4 to 10 ventilation channels leading with said first openings into the outer radial edge of said ventilation portion,
preferably, the first openings corresponding to the most peripheral ventilation channels of each cluster have a greater surface extension, preferably a greater extension in the circumferential direction, than the first openings corresponding to the innermost ventilation channels of each cluster.

19. The disc according to claim 17, wherein each of said clusters has a circumferential width comprised in the range from about 25° to about 60°, preferably from about 30° to about 45°, more preferably of about 36°.

20. The disc according to claim 17, wherein said ventilation portion comprises a number of clusters comprised between 6 and 14, preferably between 8 and 12, more preferably equal to 10.

21. The disc according to claim 17, wherein said first openings are equidistant from each other.

22. The disc according to claim 17, wherein
each of said clusters comprises 4 ventilation channels, said ventilation channels comprise a first peripheral ventilation channel, a second peripheral ventilation channel, and two inner ventilation channels placed between said peripheral ventilation channels,
said peripheral ventilation channels lead into the outer radial edge of said ventilation portion with first openings having a greater surface extension, preferably a greater extension in the circumferential direction, than the first openings of the inner ventilation channels.

23. The disc according to claim 17, wherein each ventilation channel has a cross-section in a plane perpendicular to the rotation axis, said cross-section being defined by:
an arc of circumference at said outer radial edge of the ventilation portion;
two straight lines converging away from said outer radial edge, said straight lines being delimited by two first ends which correspond to the ends of said arc of circumference and by two second ends, and
two parallel or substantially parallel straight lines which extend starting from said second ends up to one of said compartments.

24. The disc according to claim 17, wherein said first openings have the shape of slots or an elliptical or substantially elliptical shape, and/or said second openings have a circular or substantially circular or elliptical or substantially elliptical shape.

25. The disc according to claim 17, comprising a plurality of axial ventilation channels which lead with respective openings into the braking surfaces of said plates, said axial ventilation channels being adapted to provide a flow of cooling fluid substantially orthogonal to the flow of cooling fluid flowing in said ventilation channels circumferentially distributed over at least two rows in the ventilation portion.

26. The disc according to claim 17, wherein each layer of carbon fibers comprises a plurality of radial segments and transverse segments placed side by side and joined together to form said layer,
wherein the radial segments are segments in which the carbon fibers are mainly oriented in a radial direction relative to said overlap axis, and the transverse segments are segments in which the carbon fibers are mainly oriented in a direction incident to said radial direction, preferably the incident direction being substantially orthogonal to the radial direction,
wherein each radial segment is adjacent and joined, on both sides, to a transverse segment, and each transverse segment is adjacent and joined, on both sides, to a radial segment, thus forming in each layer an alternation of radial segments and transverse segments.

27. The disc according to claim 26, wherein, relative to the overlap axis, the segments of a layer are angularly offset with respect to the segments of an adjoining layer so that the joining zones between the segments do not overlap through the thickness of said disc.

28. The disc according to claim 26, wherein the segments develop as a spiral around said overlap axis in a substantially continuous manner through the plurality of layers of carbon fibers, preferably each layer (or coil) having an inclination comprised in the range from 1° to 10°, more preferably from 1° to 5°, for example of about 1°, relative to an axis orthogonal to the overlap axis.

29. The disc according to claim 26, wherein the segments are in the form of a circular crown arc having a circumferential width comprised in the range 60-90°, for example of about 68°.

30. The disc according to claim 26, wherein each segment mainly or exclusively comprises unidirectional carbon fibers, arranged either in the radial direction or in the incident direction,
preferably, at least part of the carbon fibers, preferably all the carbon fibers, are derived from oxidized polyacrylonitrile fibers.

31. The disc according to claim 26, comprising silicon carbide (SIC) obtained by reaction of part of the carbon (C) of said carbon fibers and/or of a carbonaceous matrix of the disc with at least part of the silicon (Si) infiltrated into said disc, preferably the silicon carbide (SIC) being arranged to bridge adjacent layers of carbon fibers.

32. The disc according to claim 26, wherein said disc has a residual porosity of less than 5%, for example equal to or less than 3%.
